(19) United States
(12) Patent Application Publication
(10) Pub. No.: US 2026/0224328 A1
(43) Pub. Date: Aug. 6, 2026

(54) DENTAL MICRO-ABRASIVE DELIVERY DEVICE

(71) Applicant: Boaz Barry Groman, Boca Raton, FL (US)

(72) Inventor: Boaz Barry Groman, Boca Raton, FL (US)

(21) Appl. No.: 19/577,426

(22) Filed: Mar. 25, 2026

Related U.S. Application Data
(63) Continuation-in-part of application No. 18/600,722, filed on Mar. 10, 2024.
(60) Provisional application No. 63/451,225, filed on Mar. 10, 2023.
(60) Provisional application No. 63/776,965, filed on Mar. 25, 2025.

(51) Int. Cl. A61C 3/025

(52) U.S. Cl. CPC A61C 3/025

(57) ABSTRACT

Dental micro-abrasive (powder) delivery device has a reservoir (powder chamber or cartridge) containing powder, and a refillable reservoir (fluid reservoir, chamber or cartridge) fillable with and containing a fluid (water). The device is connected to a supply of pressurized air (dental handpiece adapter) to create an airstream passing through the device. Leveraging Bernoulli's principle, the construction of the device creates low pressure areas for sucking powder and fluid from their respective chambers. An aperture exposure control (actuator) is provided to control the amount of powder being supplied in the airstream, and can also be used to select a fluid only (no powder) spray. A hybrid (integrated) device for delivering micro-abrasive shrouded by a water mist is disclosed.

### CROSS-REFERENCE(S) TO RELATED APPLICATIONS

This application claims priority (filing date benefit) from the following, as:
a nonprovisional filing of U.S. 63/776,965 filed 25 Mar. 2025
a continuation-in-part of U.S. Ser. No. 18/600,722 filed 10 Mar. 2024 (published as US 2024/0299129, 12 Sep. 2024), which may be referred to herein as “parent application”
   U.S. Ser. No. 18/600,722 is a nonprovisional filing of U.S. 63/451,225 filed 10 Mar. 2023 all of which are incorporated by reference herein.

### TECHNICAL FIELD

The invention relates generally to the field of devices for propelling (blasting) powder with intent to polish or abrade (such as etch) the surface of a target material (such as a tooth). More specifically, the present invention relates to an air polishing or air abrasion (such as micro-abrasive) blasting device powered by a pressurized-gas source for use with dental procedures. The device disclosed herein may be referred to as a DENTAL MICRO-ABRASIVE DELIVERY DEVICE.

### BACKGROUND

Abrasive blasting devices operate on the physical property that gas at a higher pressure flows towards and into gas at lower pressure. When abrasive powder is mixed with gas at higher pressure, the gas carries the abrasive powder as the gas accelerates and flows to the lower pressure. As the gas and abrasive powder blast the target material at high speed, the impact of the particles removes layers of the target material.

In dentistry this technology is known as micro-abrasion and is used to achieve a variety of goals-such as to remove foreign material or to dull a shiny surface, roughen or etch the surface to enhance bonding quality and to remove decay by drilling and cutting tooth structure.

When mild powder is used in micro-abrasion devices, the target surface is not abraded but rather is polished. Such powders are used in prophylaxis procedures where the intent is for the removal of extrinsic stain, dental plaque and soft debris while simultaneously polishing tooth surfaces. Such procedures normally use sodium bicarbonate and calcium carbonate types of powders.

The following US patents and publications are illustrative of some dental micro-abrasive blasting devices (or tools) which may be disposable and to which the present invention may be applicable (or adapted), and are incorporated by reference herein.
U.S. Pat. No. 9,050,156 2015 Jun. 9 Groman
U.S. Pat. No. 8,632,378 2014 Jan. 21 Groman
U.S. Pat. No. 8,529,313 2013 Sep. 10 Groman
U.S. Pat. No. 8,360,826 2013 Jan. 29 Groman
U.S. Pat. No. 8,241,094 2012 Aug. 14 Groman
20120171636 2012 Jul. 5 Groman
U.S. Pat. No. 7,927,188 2011 Apr. 19 Groman
U.S. Pat. No. 7,731,570 2010 Jun. 8 Groman
U.S. Pat. No. 7,607,972 2009 Oct. 27 Groman

The devices disclosed in these publications may be referred to as “Groman devices”, and are disposable devices with a limited amount of particulate matter (micro-abrasive powder) contained in the device. U.S. Pat. No. 7,607,792 is a useful example of a Groman device.

U.S. Pat. No. 7,607,972 discloses Self-contained disposable micro-abrasive blasting tip for dental application. A micro-abrasive blasting device (75) is constructed from a disposable pipette structure (80) comprising a delivery conduit (30) extending from a delivery conduit inlet (35) through a tapered section (33) to form a delivery conduit outlet (37) and a inlet port (27); contiguous pipette structure (80) expands from inlet port (27) to form a hollow bulb mixing chamber (23) and then narrows to form a discharge port (29) section; a discharge conduit (10) is in fluid communications with discharge port (29) and extends from a discharge conduit inlet (12) internal to mixing chamber (23) to a discharge conduit outlet (14) external to mixing chamber (23); a particulate matter (50) is disposed within mixing chamber wall (25); discharge conduit inlet (12) abuts inlet port (27) preventing particulate matter (50) from exiting mixing chamber 23. A separation gap (45) between the delivery conduit outlet (37) and discharge conduit inlet (12) is created as discharge conduit (10) is displaced so discharge conduit inlet (12) no longer abuts inlet port (27); As pressurized-gas is supplied to micro-abrasive blasting device (75) through the delivery conduit inlet (35), the pressurized-gas flows through the delivery conduit (30) and out of the inlet port (27), into mixing chamber (23). As flow is initiated, particulate matter (50) instantaneously mixes with the gas-steam within hollow resilient bulb mixing chamber (23) and the powder-gas mixture flows through discharge conduit (10) to strike target surface (40). FIGS. 3A,B,C thereof are illustrative, and are reproduced herein as FIGS. 1A,B,C. As described therein:
Referring to FIG. 3, a micro-abrasive blasting device 75 is disclosed; Micro-abrasive blasting device 75 comprises a mixing chamber 23 formed by a mixing chamber wall 25 and supports a inlet port 27 and a discharge port 29; a delivery conduit 30 extending from a delivery conduit inlet 35 external to mixing chamber 23 to a delivery conduit outlet 37 internal to mixing chamber 23, by means of protruding into mixing chamber 23 through mixing chamber wall 25 at inlet port 27; a discharge conduit 10 is in fluid communications with mixing chamber 23 at discharge port 29, and extending from a discharge conduit inlet 12 internal to mixing chamber 23 to a discharge conduit outlet 14 external to mixing chamber 23; a particulate matter 50 is disposed within mixing chamber 23.
Delivery conduit 30 comprises a delivery conduit external section 32 external to mixing chamber 23 and a delivery conduit internal section 34 internal to mixing chamber 23 and a connecting delivery conduit tapered section 33; external section 32 of delivery conduit 30 is preferably straight and preferably supports an outer and inner diameter that fits into standard tube and hose connectors such as push-in or push-on connector types; internal section 34 of delivery conduit 30 preferably supports an inner diameter that is equivalent to the outer diameter of discharge conduit inlet 12.

US 2024/0299129 (2024 Sep. 12; Groman) discloses WATER SUPPRESSION SYSTEM FOR DENTAL AIR-PARTICLE SURFACE TREATMENT SYSTEMS. A water source having a flexible tube for discharging water is provided for use in conjunction with a micro-abrasive blasting device so that water may be dispensed onto or around or in close proximity with the distal end or tip of the discharge conduit of said device to generate a water mist for suppressing powder aeration when dental procedures such as abrasion or polishing procedures are being performed. The water source may be separate from or self-contained with the micro-abrasive blasting device. An overlay water nozzle may be used to position distal ends of the flexible tube and discharge conduit in close proximity with one another. FIG. 2 is illustrative of the principle of operation, and is reproduced herein as FIG. 2. As described therein:
A splitter component 240 has been shown for providing compressed air from the dental chair to both the abrasive component 210 and the water supply component 220. It is also possible, and within the scope of the invention to eliminate the splitter component 240 and supply the compressed air only to the abrasive component 210. In such a case, and with distal ends of the water supply tube 227 and the air/abrasive supply tube 217 in close proximity with one another, air exiting the distal end (tip) of the air/abrasive supply tube 217 may cause a pressure drop at the nearby distal end (tip) of the water supply tube sufficient to cause a small amount of water to be expelled from the water supply tube 227. Reference Bernoulli. This has the advantage that water is expelled only when, and in synchronization with, water/abrasive being delivered to the target (tooth) being treated. An example of relying on the pressure drop to control water delivery is shown and discussed in the FIG. 3 embodiment.

### SUMMARY

In the main, hereinafter, a micro-abrasive blasting device may be referred to simply as a “device”, and said device may be handheld and may be used to perform dental procedures such as abrasion or polishing procedures such as, but not limited to cavity prep, micro etching, and prophylaxis procedures.

It is an object of the invention(s) disclosed herein to provide improved tools and techniques for delivering micro-abrasive material during dental procedures.

The typical microetching procedure to abrade tooth surfaces for bond enhancement requires small amounts of abrasive powder since the procedures are localized—usually 1 or 2 teeth at a time—only require about 0.5 grams of aluminum oxide. The Groman devices disclosed above are suitable for these procedures.

Longer duration microetching procedures, usually performed by orthodontists to mount brackets require sufficient powder for abrading one side of the tooth surface on the arch—typically 16 teeth—about 2 grams of aluminum oxide (“powder”).

However, prophylaxis and cavity preparation procedures utilizing powder blasting require substantially more powder. In case of prophylaxis procedures, every tooth surface is sprayed with soft polishing powder. Since every patient differs in amounts of biofilm, stain and calculus, sometimes additional powder is required to properly complete the prophylaxis treatment.

Pre-packaged prophy powders (such as Prophyflex Air Polishing Powder Packets by Kavo America Dental Corp.) usually are sold in 15 grams pouches and larger packages. Common prophy powders are Sodium bicarbonate, Calcium carbonate, glycine, Alum. Hydroxide and others.

In case of cavity preparation, hard abrasive powder such as aluminum oxide is utilized to remove tooth structure at high operational pressures. There are several types of cavity preparation procedures some with long duration, some which require substantial tooth removal and therefore require substantially more powder than 2 grams.

And while microetching procedures require low to moderate operational air pressures (40 psi-60 psi), prophylaxis procedures benefit from high air pressures (60 psi to 80 psi) since the powders are soft and cavity preparation benefits from high air pressures (80 psi to 120 psi) for rapid tooth structure removal.

Current devices for jet polishing consist of desktop equipment (powder in desktop containers fed to handpiece), handheld equipment (powder is in a container built into the handheld device, and the single-use Groman devices described hereinabove.

The equipment is expensive and requires substantial cleaning, brushing, and autoclaving of the various components between uses and components wear out require costly replacement parts.

Ideally, prophylaxis and cavity preparation procedures require devices with long reach into oral cavity and a bendable nozzle so every tooth is reachable on all sides.

The Groman devices are prefilled with soft powders and are suitable for polishing, biofilm removal, and tooth surface reflection/color blending of surfaces when needed. The procedures are localized (a few teeth) since there isn't sufficient powder within the bulb to perform full mouth prophy procedures.

The Groman devices utilize pressurized air flow into a mixing chamber (element 23 in U.S. Pat. No. 7,607,972) which is about half-filled with powder. When pressurized air is applied to the chamber the air and powder mix within the chamber and exit out the nozzle. The high operational pressure driven into the chamber requires a strong chamber structure. Additionally, since the mixing chamber also facilitates the air-powder mixing, the chamber size gets twice as large for every quantity of added powder-powder volume plus equal mixing volume. Therefore, the microetching technology of the Groman devices is not scalable for full mouth prophylaxis and extensive cavity preparation procedures.

The DENTAL MICRO-ABRASIVE DELIVERY DEVICE disclosed herein, solves the above issues with a single-use device that consists of a powder container that 1) is not exposed to high pressure therefore can be constructed of thin material, 2) does not require chamber volume for mixing thereby making the device chamber smaller and 3) operates in conjunction with an external lightweight disposable bag which can be filled with any type of powder by the user simply by filling the bag and closing a Ziplock.

The powder container (bag, pouch) can be fabricated from standard plastic bag materials or other packaging materials. They are environmentally friendly due to the thin wall requirement not achievable when the container is exposed to high inlet air pressures.

In an embodiment, the bag may be completely separate from the DENTAL MICRO-ABRASIVE DELIVERY DEVICE.

In an embodiment, the bag is integral to the device where the bag is permanently mounted, such as impulse heat-sealed or ultrasonic sealing to the device. This generally requires that the device and bag be made from similar materials, such as polyethylene.

According to the invention, generally, a dental micro-abrasive delivery device may comprise a tubular structure having: an inlet portion adapted to connect with a pressurized air supply from the dentist's chair; a reducer portion in downstream fluid communication with the inlet portion; an outlet portion in downstream fluid communication with the reducer portion and having a diameter greater than the reducer portion; a nozzle extending from the outlet portion; an inlet orifice (low pressure inlet, aperture; slot) at the inlet end of the outlet portion, slightly downstream of the reducer portion; and means for supplying micro-abrasive in powder form to the inlet orifice. Means are provided to selectively block, partially block, or open the inlet orifice, thereby controlling the amount of micro-abrasive powder being supplied in an airstream passing through the device.

According to an embodiment of the invention, a dental micro-abrasive delivery device (“device”) may comprise a tubular structure having: an inlet portion adapted to connect with a pressurized air supply from the dentist's chair; a reducer portion in downstream fluid communication with the inlet portion; an outlet portion in downstream fluid communication with the reducer portion and having a diameter greater than the reducer portion; and an inlet orifice (low pressure inlet, aperture; slot) at the inlet end of the outlet portion, slightly downstream of the reducer portion.

The device may further comprise a nozzle extending from the outlet portion. (FIG. 6) The nozzle may be flexible. The nozzle may be movable to selectively block, partially block, or open the inlet orifice. (FIGS. 11A,B,C)

Means may be provided for supplying micro-abrasive in powder form to the inlet orifice. The means may comprise a powder pouch. (FIG. 8B) The means may comprise a polyethylene bag. (FIG. 8C,D)

A platform may be disposed atop the tubular structure. (FIG. 9A) A bag containing micro-abrasive powder may be mounted to the platform. (FIG. 9B) The aperture (slot) may extends through the platform. A movable cover element may be provided for selectively covering the aperture.

In use for performing a dental procedure, pressurized air is provided to the device, and the amount of micro-abrasive powder being supplied in an airstream passing through the device may be controlled.

The present invention may be compared and contrasted with the apparatus shown in U.S. Pat. No. 7,607,972 in the following ways:
in '972, the abrasive is ejected due to pressurized air entering the apparatus
in '972, the abrasive is self-contained in the apparatus,
in the present invention, the abrasive is external to the apparatus, and
in the present invention, the abrasive is sucked out of the supply by low pressure.

The present invention may be compared and contrasted with the apparatus shown in US 2024/0299129 (the '9129 device) in the following ways:
both leverage the Bernoulli principle that an increase in the flow velocity of an ideal fluid will be accompanied by a simultaneous reduction in its pressure in order to “draw” a substance (water in the '9129 device; abrasive material in the present invention) from a supply that is at atmospheric pressure;
the present invention allows for powder to be introduced into the main body of the device and mix with an air stream passing through the device; and
in the '9129 device, water is drawn by reduced pressure external to the device (at the extreme distal end of the device), and is not mixed with an air stream passing through the device.

Other objects, features and advantages of the invention(s) disclosed herein, and their various embodiments, may become apparent in light of the descriptions of some exemplary embodiments presented herein.

### BRIEF DESCRIPTION OF THE DRAWINGS

Reference will be made in detail to embodiments of the disclosure, non-limiting examples of which may be illustrated in the accompanying drawing figures (FIGs). The figures may generally be in the form of diagrams. Some elements in the figures may be exaggerated, others may be omitted, for illustrative clarity. Some figures may be in the form of diagrams.

Although the invention may be described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

FIG. 1A (compare FIG. 3A of U.S. Pat. No. 7,607,972) is a cross-sectional view of a micro-abrasive blasting device, according to the prior art.

FIG. 1B (compare FIG. 3B of U.S. Pat. No. 7,607,972) is a cross-sectional view of a micro-abrasive blasting device, according to the prior art.

FIG. 1C (compare FIG. 3C of U.S. Pat. No. 7,607,972) is a cross-sectional view of a micro-abrasive blasting device, according to the prior art.

FIG. 2 (compare FIG. 2 of US 2024/0299129) is a diagram of a micro-abrasive blasting system comprising a micro-abrasive mixing device and a water supply mounted thereto, for performing a dental procedure on a patient, according to the parent application.

FIG. 3 (compare illustration at the top of page 1 of APPENDIX 1) is a diagram illustrating the basic physics (Bernoulli's Principle) involved in the operation of the inventive micro-abrasive delivery device disclosed herein.

FIG. 4 (compare illustration at the middle of page 1 of APPENDIX 1) is a diagram illustrating a simple embodiment of the invention, with air being introduced at a low pressure inlet of the dental micro-abrasive delivery device disclosed herein.

FIG. 5 (compare illustration at the bottom of page 1 of APPENDIX 1) is a diagram illustrating a simple embodiment of the invention, with powder being introduced at the low pressure inlet of the dental micro-abrasive delivery device disclosed herein.

FIG. 6 (compare illustration at the top of page 2 of APPENDIX 1) is a diagram illustrating an embodiment of the invention with a long bendable nozzle.

FIG. 7 (compare illustration at the bottom of page 2 of APPENDIX 1) is a diagram illustrating an embodiment of the invention with a powder container base and an angled bendable nozzle.

FIG. 8A (compare illustration at the top of page 3 of APPENDIX 1) is a diagram illustrating an embodiment of the invention, as modeled.

FIG. 8B (compare illustration at the bottom of page 3 of APPENDIX 1) is a diagram illustrating an embodiment of the invention, using a powder pouch, mounted to a dental handpiece adapter.

FIG. 8C (compare illustration at the top of page 4 of APPENDIX 1) is a diagram illustrating an embodiment of the invention, using a standard polyethylene bag containing micro-abrasive powder pierced by a dental micro-abrasive delivery device.

FIG. 8D (compare illustration at the bottom of page 4 of APPENDIX 1) is a diagram illustrating an embodiment of the invention, using a standard polyethylene bag containing micro-abrasive powder, showing an air/powder stream exiting the nozzle of a dental micro-abrasive delivery device.

FIG. 9A (compare illustration at the top of page 5 of APPENDIX 1) is a diagram illustrating an embodiment of the invention showing a dental micro-abrasive delivery device having a platform for receiving a bag containing micro-abrasive powder.

FIG. 9B (compare illustration at the bottom of page 5 of APPENDIX 1) is a diagram illustrating an embodiment of the invention showing the bag containing micro-abrasive powder mounted (sealed) to the platform of the dental micro-abrasive delivery device.

FIG. 10A (compare illustration at the top of page 6 of APPENDIX 1) is a diagram illustrating an embodiment of the invention showing a dental micro-abrasive delivery device having a platform for receiving a bag containing micro-abrasive powder, with an aperture exposure control incorporated into the device, with the lever of the aperture exposure control in a sealed (closed) position.

FIG. 10B (compare illustration at the middle of page 6 of APPENDIX 1) is a diagram illustrating an embodiment of the invention showing a dental micro-abrasive delivery device having a platform for receiving a bag containing micro-abrasive powder, with an aperture exposure control incorporated into the device, with the lever of the aperture exposure control in a half-open position.

FIG. 10C (compare illustration at the middle of page 6 of APPENDIX 1) is a diagram illustrating an embodiment of the invention showing a dental micro-abrasive delivery device having a platform for receiving a bag containing micro-abrasive powder, with an aperture exposure control incorporated into the device, with the lever of the aperture exposure control in a full-open position.

FIGS. 11A,B,C are diagrams illustrating an embodiment of the invention wherein aperture exposure is implemented by moving the nozzle in and out (axially) to selectively expose none, some or all of the aperture. Compare FIG. 6.

FIG. 12 (compare FIG. 5B of the parent application US 2024/0299129) is an illustration (cross-sectional view) of an “overlay water nozzle”, wherein distal ends of a flexible tube supplying water and a discharge conduit (nozzle) supplying abrasive material and air are joined (combined) with one another at their distal end portions by a tube attachment for delivering water and air (with abrasive) to a target, according to an embodiment of the invention.

FIG. 13 is an illustration (side view, partially transparent) of a hybrid (integrated) powder and water delivery device, according to the invention.

FIG. 14 (compare page 1 of APPENDIX 2) an illustration (side view, partially transparent) of a hybrid (integrated) powder and water delivery device, according to the invention.

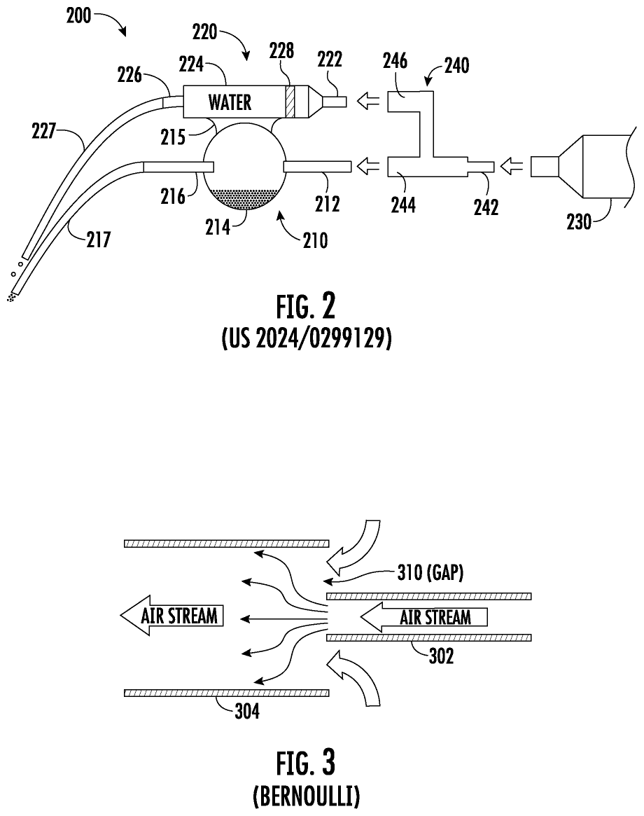

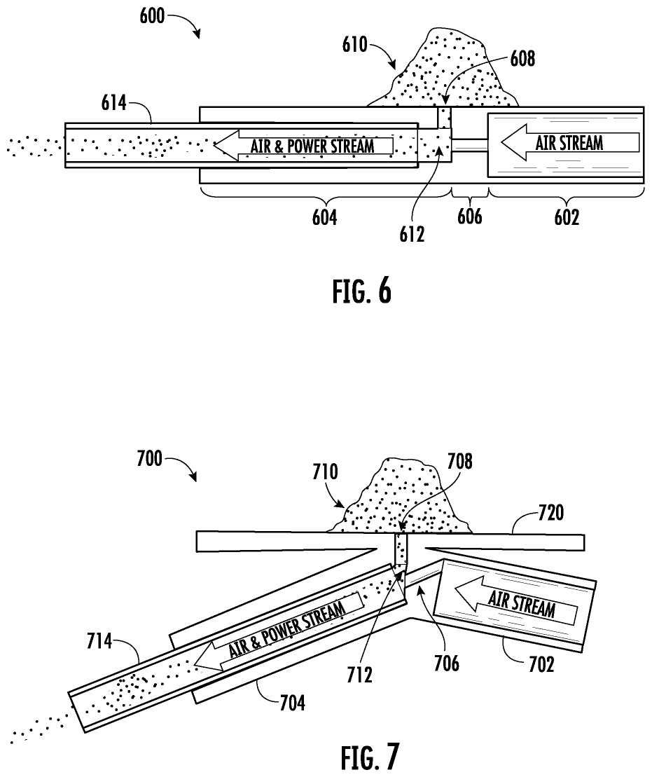

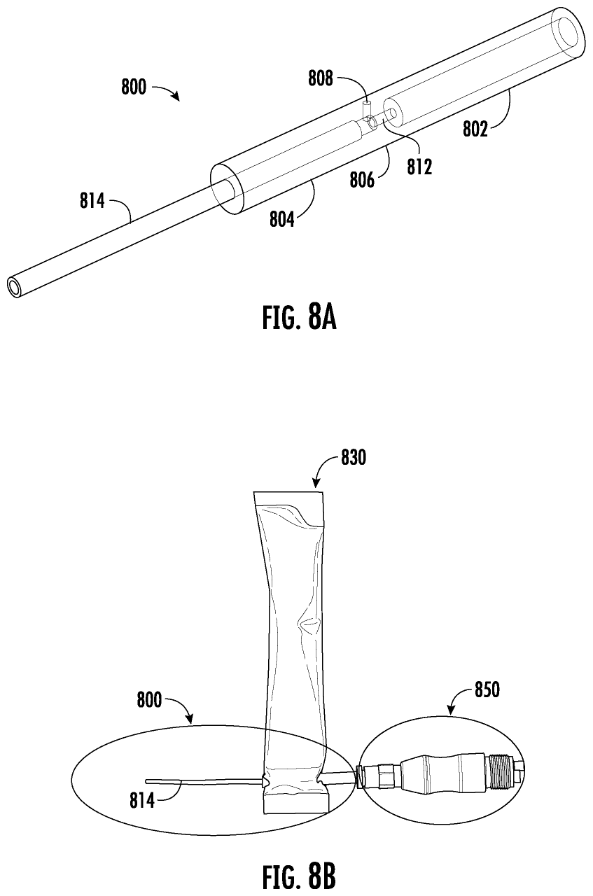

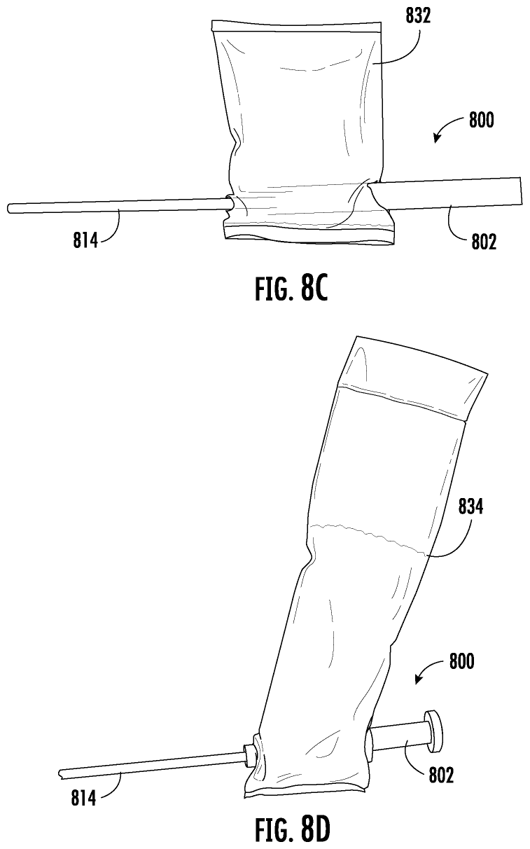

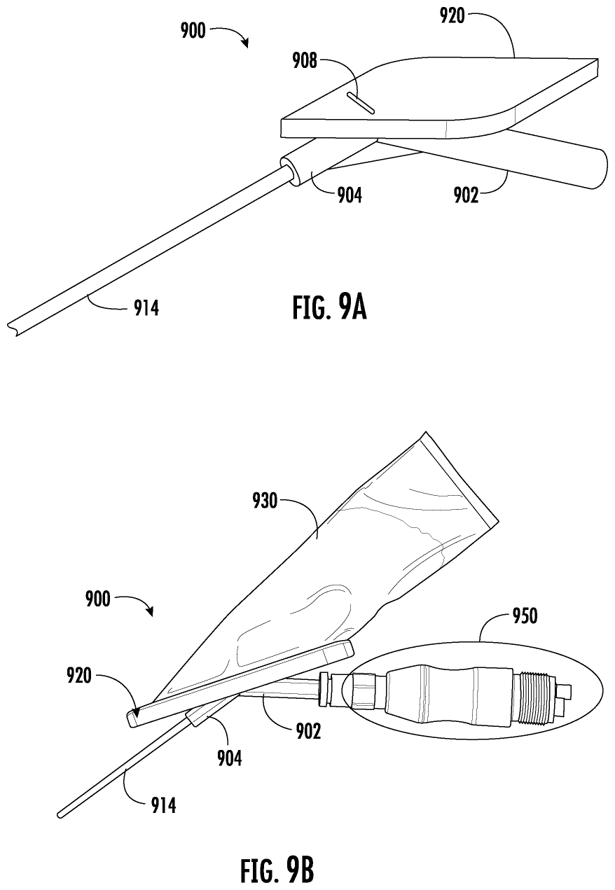

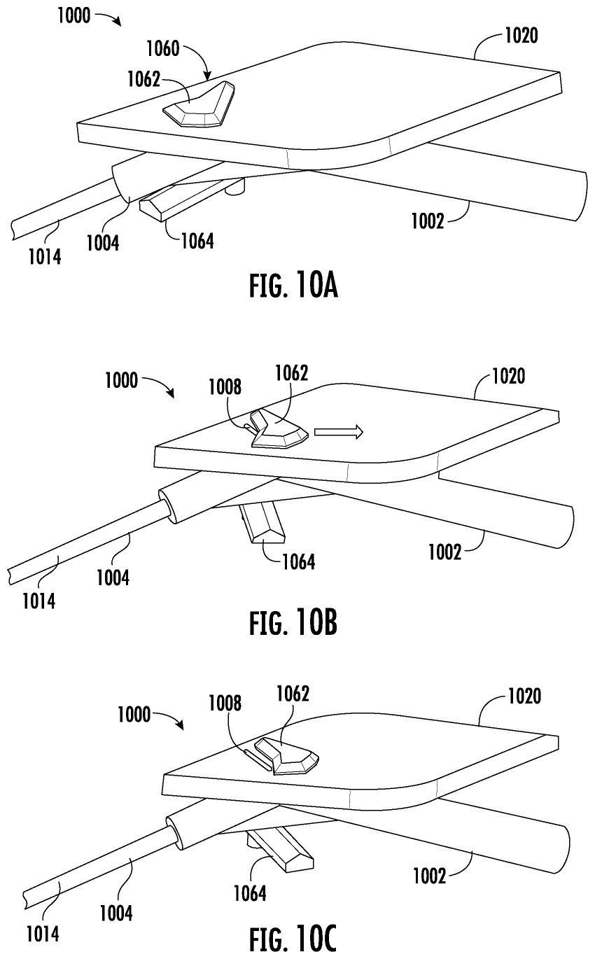

An Appendix (APPENDIX 1) having 7 pages is being filed herewith. Some of the drawing figures presented herein may correspond to illustrations in the Appendix, as follows:
FIGS. 3,4,5 illustrations at page 1 of APPENDIX 1
FIGS. 6,7 illustrations at page 2 of APPENDIX 1
FIGS. 8A,B illustrations at page 3 of APPENDIX 1
FIGS. 8C,D illustrations at page 4 of APPENDIX 1
FIGS. 9A,B illustrations at page 5 of APPENDIX 1
FIGS. 10A,B,C illustrations at page 6 of APPENDIX 1

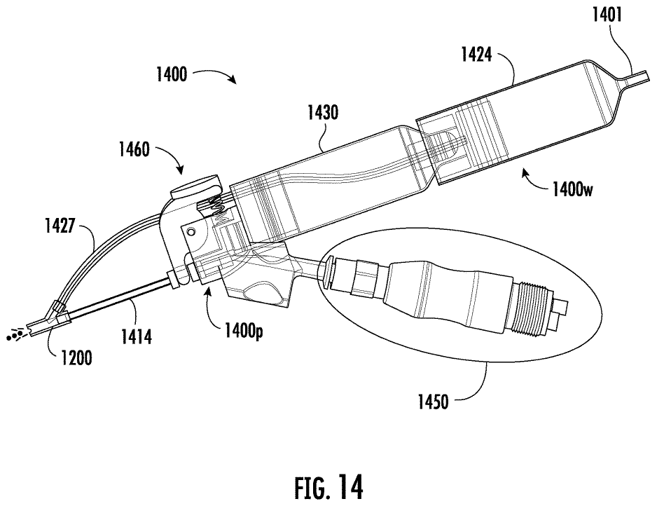

An Appendix (APPENDIX 2) having 9 pages is being filed herewith. Some of the drawing figures presented herein may correspond to illustrations in the Appendix, as follows:
FIG. 14 illustration at page 1 of APPENDIX 2

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein. Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Appended hereto and forming part of the description hereof is a 7 page document (“APPENDIX 1”) illustrating the operation and some embodiments of the invention. Some illustrations therein may be cross-referenced herein.

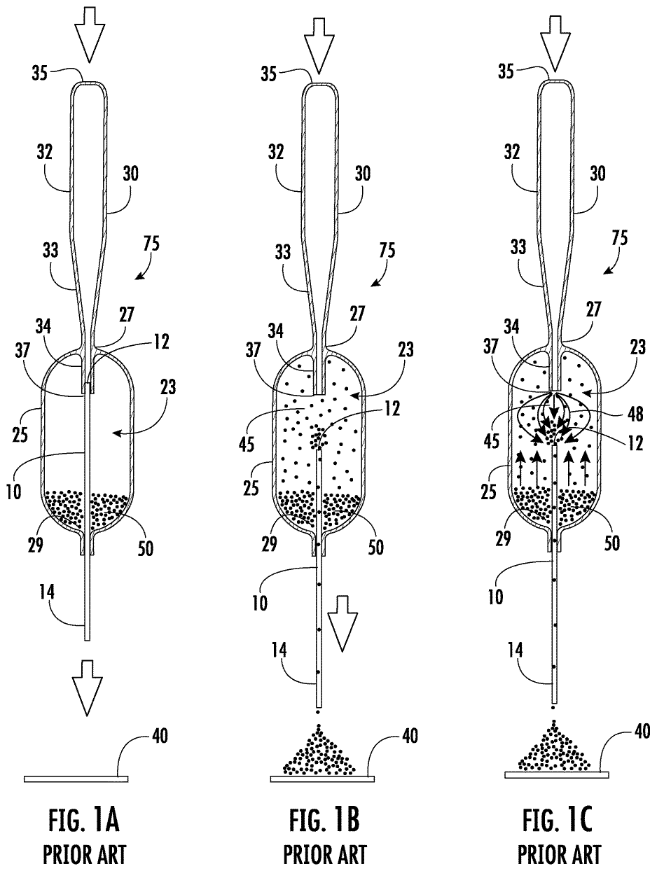

FIGS. 1 (A,B,C) and 2 are illustrative of the prior art, and have been discussed hereinabove.

FIG. 3 illustrates the basic physics (Bernoulli's Principle) involved in the operation of the inventive micro-abrasive delivery device disclosed herein.

An inlet tube 302 and an outlet tube 304 are shown. The inlet tube 302 has a smaller diameter than the outlet tube 304.

Pressurized air is supplied to an inlet end (right, as viewed) of the inlet tube from a pressurized air source (not shown) such as is commonly available on a dentist's chair. This initiates an air stream in the inlet tube which is directed into the outlet tube. The air stream in the outlet tube is discharged to the atmosphere. In some of the embodiments disclosed herein, the air stream is shown traveling from the inlet end (right, as viewed) of the inlet tube 302, through the inlet tube 302, into the inlet end (right, as viewed) of the outlet tube 304, and exiting the outlet end (left, as viewed) of the outlet tube 304.

An outlet end (left, as viewed) of the inlet tube is disposed near or at an inlet end (right, as viewed) of the outlet tube, such as coaxially therewith. Since the outlet tube is larger (has a greater diameter) than the inlet tube, there is a small gap 310 around the outlet end of the inlet tube and the inlet end of the outlet tube.

Due to the increase in diameter (gap) at the interface of the outlet of the inlet tube (Reducer) and inlet end of the outlet tube (Nozzle), and based on Bernoulli's Principle, a region of low air pressure develops at the gap around the outlet end of the inlet tube and the inlet end of the outlet tube. This (low pressure) will cause ambient air to be pulled into the gap-more accurately, the higher ambient pressure will cause air to be pushed into the gap. The air that is pulled into the gap will mix with the air stream in the outlet tube. In provisional application 63/451,225, this feature was described as follows. The tube diameter expansion (from inlet tube to outlet tube) generates a low pressure within the outlet tube, pulling (sucking, drawing) air into the outlet tube. The large, curved arrows in the figure are intended to represent this pulling phenomenon.

Note: In provisional application 63/451,225, the outlet tube may have been referred to as a “nozzle”. In some embodiments disclosed herein (e.g., FIGS. 6, 7), a separate nozzle element may be incorporated into the device.

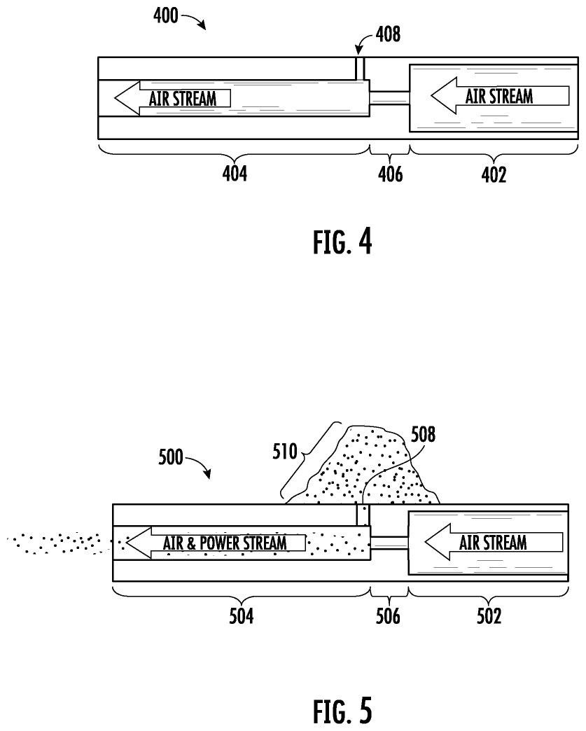

FIG. 4 illustrates a “partial” (preliminary, prototype) embodiment of the invention, with pressurized (above ambient) air being introduced, such as into an inlet end of a dental micro-abrasive delivery device 400.

In this, and some other embodiments disclosed herein, pressurized air may be introduced from any suitable pressurized air source, typically from a dental chair coupler (not shown).

The device 400 comprises a generally tubular structure having;
an inlet portion 402 (compare inlet tube 302 of FIG. 3),
an outlet portion 404 (compare outlet tube/304 of FIG. 3), and
a reducer portion 406 disposed between the inlet portion and the outlet portion.

Each of the inlet, outlet and reducer portions may be generally cylindrical, each having an inner diameter (ID).

The reducer portion has a smaller diameter (or cross-sectional area) than the outlet portion. This is comparable to the FIG. 3 illustration wherein the inlet tube (reducer) has a smaller diameter than the outlet tube (nozzle). Thus, due to the increase in diameter (gap) at the interface of the reducer portion 406 and the inlet end (right end, as viewed) of the outlet portion 404, and based on Bernoulli's Principle, a region of low air pressure develops at the inlet end of the outlet tube. In other words, as applied to this FIG. 4 embodiment, when the airstream passing through the device 400 expands from its size (diameter, cross-sectional area) in the reducer portion 404 to a larger size in the outlet portion 404, a region of low (lower than ambient) pressure develops in the outlet portion 404.

The device 400 further comprises an aperture (inlet orifice; low pressure inlet) 408 (compare gap 310 in FIG. 3) extending from an outer (external) surface of the device 400 to a position at or near the inlet end of the outlet portion 404. This embodiment is provided to illustrate the basic construction and operation of the device 400, and is not intended to be a fully functional DENTAL MICRO-ABRASIVE DELIVERY DEVICE because, among other things, an abrasive material (powder) is not yet incorporated into the device.

In use (when pressurized air is provided to the inlet portion 402, ambient air pressure (~1000 mbar; ~760 mmHg; ~14 psi), a pressure lower than ambient is developed in the outlet portion 404 which will cause ambient air outside of the device 400 to be “sucked” into the outlet portion 404 of the device 400. Stated otherwise, the ambient air pressure external to the device 400 will push air into the lower-pressure space within the outlet portion 404 of the device. The aperture 408 provides a low pressure inlet to the interior of the device 400 to allow ambient (external to the device) air to flow into the device and combine with the air stream (“Air Stream”) passing through the device.

As will be apparent in the embodiment described with respect to FIG. 5, the airflow through the aperture 408 into the outlet portion 404 may be used to transport (inject, convey) a quantity of particulate matter (powder) into the outlet portion of the device to be combined with the airstream passing through the outlet portion of the device.

When pressurized (above atmospheric) pressure is provided (not shown, compare FIG. 3), such as from a dental chair coupler (not shown) to the inlet portion 402, passes through the reducer portion 406, and thereafter passes through the outlet portion 404, the pressure in the outlet portion 404 will be less than ambient, and this will result in a low pressure air flow through the aperture 408 into the outlet portion 404. This is comparable to the FIG. 3 illustration wherein due to low pressure, ambient air is drawn into the gap between the outlet end of the inlet tube and the inlet end of the outlet tube. In other words, the gap shown in FIG. 3 is comparable (functionally) to the aperture 408.

Although, at first glance, introducing ambient air (via the aperture) into the airstream passing though the outlet portion of the device may, in and of itself not seem significant, it will become apparent, in the device described with respect to FIG. 5, that causing ambient air to be drawn through the aperture 408 into the airstream passing through (and ejected by) the device may beneficially be utilized to introduce a particulate (powder) into the airstream exiting the device.

The diameter of the inlet portion (inlet tube) of the device may be larger then the diameter of the reducer portion. This does not play a significant role in the “physics” of operation of the device, only in the regards that smaller inlet tube diameters reduce air flow, i.e. for maximum efficiency it is better to keep the supply source large diameter. The diameter of the inlet portion is selected to be suitable for interfacing with a pressurized air supply such as from a dentist's chair coupler. preferably supports an outer and inner diameter that fits into standard tube and hose connectors such as push-in or push-on connector types.

Some exemplary dimensions for the inlet, outlet, and reducer portions, and aperture may be:
the inner diameter (ID) of the inlet portion 402 may be 2.88 mm (0.113 inch),
the inner diameter (ID) of the outlet portion 404 may be 1.37 mm (0.054 inch),
the inner diameter (ID) of the reducer portion 406 may be 0.89 mm (0.035 inch),
the diameter of the aperture 408 may be 2.00 mm (0.079 inch).
the inlet portion 402 of the device may have a length of approximately 35 mm, and an inner diameter (ID) of approximately 2.8 mm;
the outlet portion 404 of the device may have a length of approximately 10 mm, and an inner diameter (ID) of approximately 1.85 mm;
the reducer portion 406 of the device may have a length of approximately 2 mm, and an inner diameter (ID) of approximately 0.89 mm;

All dimensions provided herein may be approximate. When diameters are discussed, it should be understood that in some configurations the openings, passages, apertures and the like may not be circular, in which case diameter may be construed to mean cross-dimension.

FIG. 5 illustrates an embodiment of a dental micro-abrasive delivery device 500, according to an embodiment of the invention. The device 500 is similar to the device 400 described hereinabove, having:
an inlet portion 502 (compare 402),
an outlet portion 504 (compare 404),
a reducer portion 506 (compare 406), and
an aperture (inlet orifice; low pressure inlet) 508 (compare 408).

The device 500 may be substantially identical to the device 400 shown in FIG. 4.

A supply (quantity) of micro-abrasive material (powder) 510 is disposed at or adjacent to the aperture 508. Generally, the purpose of the aperture (vent hole) 508 is to allow particulate matter (micro-abrasive powder) to be introduced into an air stream passing through the tube. More particularly, when air is flowing through the device 500 (from a pressurized air source, not shown, see FIGS. 3 and/or 4) reduced (low) air pressure in the outlet portion 504 will cause (allow) the powder 510 to be “sucked” into the airstream flowing through the device 500 and mixed with the air stream passing through the outlet portion 504, resulting in a stream of air and powder being delivered by the device to a suitable target such as a patient's tooth.

The size (diameter, cross-dimension) of the aperture 508 controls (determines, limits) the amount (concentration) of powder 510 introduced in to the airstream in the outlet portion 504, and ultimately ejected from the outlet portion 504. The powder 510 which is at ambient pressure, is sucked through the aperture 508 into the airstream passing through the outlet portion 504 which is at less than ambient pressure, as described above (due to the increase in diameter from the reducer portion 506 to the outlet portion 504, and the Bernoulli effect/principle). FIGS. 10A,B,C illustrate a technique for selectively opening, closing, and partially closing the aperture to control the flow of powder being introduced into the airstream exiting the outlet portion 504.

FIG. 5 illustrates a basic device which may appear in a number of the embodiments disclosed herein, with additions or modifications thereto, and generally comprises (as previously described with respect to FIG. 4) a tube having:
an inlet portion adapted to connect with a pressurized air supply from the dentist's chair
a reducer portion in downstream fluid communication with the inlet portion
an outlet portion in downstream fluid communication with the reducer portion and having a diameter greater than the reducer portion
an inlet orifice (low pressure inlet, aperture) at the inlet end of the outlet portion, slightly downstream of the reducer portion.

When pressurized air is supplied to the inlet portion of the device, due to low pressure, the lower air pressure generated at the inlet end of the outlet portion of the device will cause the powder to be sucked into the outlet portion, via the inlet orifice (low pressure inlet, aperture), where it will be mixed with the air stream in the outlet portion of the device (air & powder stream), thereafter to be discharged from the outlet end of the outlet portion of the device.

The size of the aperture will control the concentration of powder introduced into the air stream in the outlet portion of the device. This includes various means for partially or full closing the aperture, as illustrated in and described with respect to FIGS. 10A,B,C and 11A,B,C, which will vary the effective size of the aperture, thereby controlling the amount of powder introduced into the airstream.

The mixing and ultimate discharge of powder and air in the outlet portion of the device is reminiscent of how particulate matter 50 is mixed with air in the mixing chamber 23 of the micro-abrasive blasting device 75 described in U.S. Pat. No. 7,607,972 and shown in FIGS. 1A,B,C above. However, whereas in the blasting device 75 the particulate matter 50 is contained in the mixing chamber 23, in the device of the present invention the powder is located external to the device.

Having a supply of powder 510 disposed adjacent the aperture, and not contained, such as shown in FIGS. 5, 6, 7 may not be practical. Nevertheless, these (and some other) figures are useful for understanding the operation of the various embodiments of the device disclosed herein. Some figures (e.g., 8B,C,D; 9B, 12A,B) may show means (such as a plastic bag) for containing the powder while allowing it to be sucked into the airstream passing through the device.

Some exemplary dimensions for the inlet, outlet, and reducer portions, and aperture may be:
the inner diameter (ID) of the inlet portion 502 may be 2.88 mm (0.113 inch),
the inner diameter (ID) of the outlet portion 504 may be 1.37 mm (0.054 inch),
the inner diameter (ID) of the reducer portion 506 may be 0.89 mm (0.035 inch), and
the diameter of the aperture 508 may be 2.00 mm (0.079 inch).

All dimensions provided herein may be approximate. When diameters are discussed, it should be understood that in some configurations the openings, passages, apertures and the like may not be circular, in which case diameter may be construed to mean cross-dimension.

Additionally, although cross-sectional lines may be shown in the figures to enhance illustrative clarity, they are not intended to determine the material (such as metal) of the device. It should further be understood that, although the aperture may appear to be blocked in the figures (due to the way it is drawn), it is not blocked.

The device 500—namely the inlet, reducer, and outlet portions (602, 604, 606 502, 504, 506)—may be made of a plastic material such as polyethylene, polypropylene, or polycarbonate, and may be manufactured using 3D printing or injection molding processes. Other embodiments similar to or utilizing the device shown in FIG. 5 may be made primarily of similar materials using similar processes, and may have similar dimensions.

The micro-abrasive material (powder) 508 may be aluminum oxide, glycine, sodium bicarbonate, calcium carbonate, Aluminum Trihydroxide, with a size of 30-90 μm.

Some embodiments subsequently described herein may include various means for containing the powder (510) and other additions to the device such as a nozzle extending from the outlet portion (504) of the device (see nozzle 614 in FIG. 6).

FIG. 6 illustrates an embodiment of a dental micro-abrasive delivery device 600, according to an embodiment of the invention. The device 600 is similar to the device 500 described hereinabove, having:
an inlet portion 602 (compare 502),
an outlet portion 604 (compare 504),
a reducer portion 606 (compare 506), and
an aperture (inlet orifice; low pressure inlet) 608 (compare 508).

A supply (quantity) of micro-abrasive material (powder) 610 is disposed at or adjacent to the aperture 608.

This embodiment (600) uses and builds upon the basic device (500) shown and described with respect to FIG. 5, with the addition of a nozzle 614 extending from the outlet portion 604 of the device 600.

The nozzle 614 may be long, and bendable, has an inner diameter (ID), and may extend from within the outlet portion 604 to without (beyond) the outlet portion. As shown in the figure, the nozzle 614 may extend within the outlet portion 604 nearly to the reducer portion 606, without blocking the aperture 608. This may be accomplished by increasing the ID of the outlet portion 604 along its length from the outer end thereof nearly (but not quite) to the reducer portion 606 and aperture 608 where the diameter of the outlet portion remains unchanged (smaller). This creates what may be termed an “expansion chamber” 612 at the inlet end (right, as viewed) of the outlet portion 604.

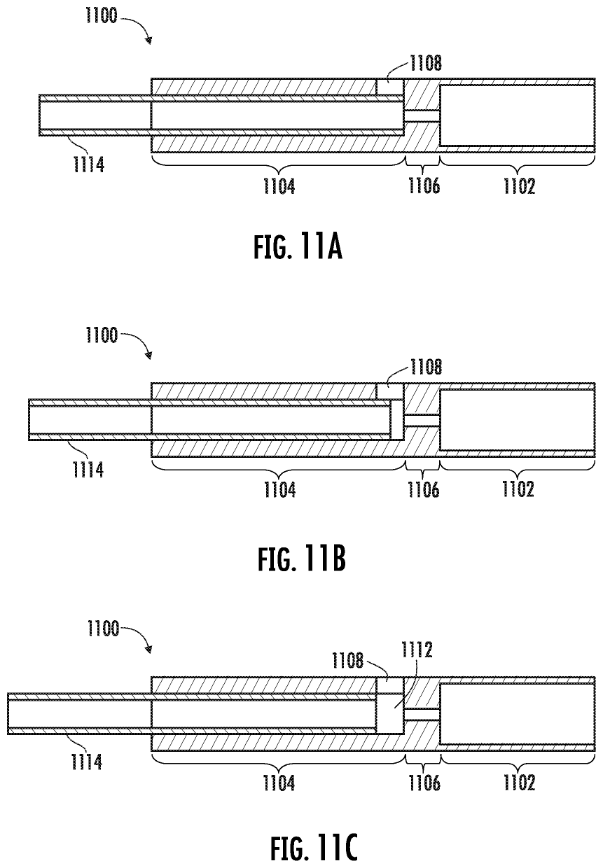

The nozzle 614 may be “fixed” (firmly embedded) within the outlet portion 604. Or, it may be movable in and out of the outlet portion, as shown and described with respect to FIGS. 11A,B,C.

The expansion chamber 612 diameter/cross-sectional area should be smaller than or equal to the inner diameter of the nozzle 614 to avoid flow disruption which would negate the negative pressure generation. In other words, the diameter of the outlet portion 604 may be enlarged to accommodate the nozzle 614 being inserted therein so that the resulting inner diameter of the outlet portion 604, including the nozzle 614, is substantially equal to the inner diameter of the outlet portion 604 without the nozzle (compare FIG. 5). In other words,
the ID of the outlet portion 604 at the expansion chamber 612 may be 1.8 mm (0.072 inch), and
the ID of the nozzle 614 may be 1.37 mm (0.054 inch).

The nozzle 614 is comparable to the discharge conduit 10 in fluid communications with mixing chamber 23 shown in FIGS. 1A,B,C in that it may be used to direct the air & powder stream exiting the device 600 at a target (the patient's tooth).

The nozzle 614 may be made of stainless steel, aluminum, or plastic, and may have an outer diameter (OD) of 1.8 mm (0.072 inch). The nozzle may be flexible, or bendable, to allow a user (such as a dentist) to better manipulate the device to treat difficult-to-access targets (such as surfaces of a patient's teeth).

An exemplary device 600, such as shown in FIG. 6 comes close to being complete and usable (except that the powder 608 is not contained,) and may have the following dimensions:
the device may have an overall length of approximately 50 mm;
the device may have an outer diameter of approximately 4.76 mm;
the inlet portion 602 of the device may have a length of approximately 35 mm, and an inner diameter (ID) of approximately 2.8 mm;
the outlet portion 604 of the device may have a length of approximately 10 mm, and an inner diameter (ID) of approximately 1.85 mm;
the reducer portion 606 of the device may have a length of approximately 2 mm, and an inner diameter (ID) of approximately 0.89 mm; and
the aperture 608 of the device may have a diameter of approximately 0.75 mm.

The nozzle 614 extends from within the outlet portion of the device to beyond the outlet end of the device, may be formed of stainless steel), and may may have a length of approximately 50 mm, an outer diameter of approximately 1.8 mm, and an inner diameter of approximately 1.4 mm.

The nozzle 614 may be firmly fitted into the outlet portion 604, extending nearly to the aperture (low pressure vent hole) 608. The nozzle 614 may be movable, able to slide in and out of the outlet portion 604. Compare the movable discharge conduit 10 show in FIGS. 1A,B,C.) Moving the nozzle in and out of the outlet portion is better illustrated in FIGS. 11A, 11B and 11C.

Note: It may be noted that in provisional 63/451,225, the device 600 (and other similar devices shown and described herein) may have been referred to as a “tube”.

When pressurized air passes through the device, due to the fact that the outlet portion has a larger diameter than the reducer portion, a low pressure develops at the reducer end of the outlet portion (in what may be termed an “expansion chamber”). This pressure differential between the expansion chamber and the ambient atmosphere causes particulate matter to be “sucked” into the outlet portion of the tube, whereupon it mixes with the air stream passing through the outlet portion of the tube (and into the nozzle).

In the example of FIG. 6, the inlet portion 602, reducer portion 606, and outlet portion 604 of the tube may all be coaxial. The nozzle 614 is shown as being coaxial with the outlet portion 604.

FIG. 7 illustrates an embodiment of a dental micro-abrasive delivery device 700, according to an embodiment of the invention. The device 700 is similar to the device 600 described hereinabove, having:
an inlet portion 702 (compare 602),
an outlet portion 704 (compare 604),
a reducer portion 706 (compare 606),
an aperture (inlet orifice; low pressure inlet) 708 (compare 608), and
a nozzle 714 (compare 614).

A supply (quantity) of micro-abrasive material (powder) 710 is disposed at or adjacent to the aperture 708.

This embodiment differs from the embodiments previously described with respect to FIGS. 5, 6 in the following ways:
the outlet portion 704 is angled with respect to the inlet portion 702, and
an additional element (powder container base) 720 is incorporated into the construction of the device.

The reasons for and advantages of angling the outlet portion 704 and providing the powder containing base 720 are described hereinbelow.

Regarding the aperture (vent hole) 708, the aperture can have a slotted (rectangular cross-section) shape, and a cover element (not shown) may be incorporated into the device to selectively close, including partially close the aperture to control the amount of particulate matter (powder) that is introduced into the air stream, such as is shown in FIGS. 10A,B,C.

In instances where no powder concentration control is required—vent hole/aperture opening can be kept constant size—the cover element and lever can be eliminated for simplicity and cost reduction, by permitting axial movement of the stainless steel nozzle where the outside surface of the stainless steel nozzle is positioned to block the vent hole/aperture. The nozzle would be pulled forward—as in U.S. Pat. No. 7,607,792 to expose the aperture. This permits a simple low-cost solution for maintaining the powder container closed until use. Refer to FIGS. 11A,B,C.

In this embodiment, the outlet portion 704 of the tube is not coaxial with the inlet portion 702 of the device 700. Rather, the outlet portion is disposed at an angle, such as 60 degrees off axis from the inlet portion. This causes the nozzle 714 to be at an angle to the inlet portion of the device, and allows for the platform (powder container base) 720 to be disposed atop the device.

A supply of powder 710 (compare 610) is shown disposed on the platform 720, and the aperture (low pressure vent) 708 extends through the platform so that the powder can be introduced into the air stream flowing through the device. More features of the platform will become apparent when describing some practical examples of the device (FIGS. 9, et seq).

FIGS. 5, 6, 7 show some examples (500, 600, 700) of the “basic” micro-abrasive delivery device wherein the abrasive material (micro-abrasive powder 508, 608, 708) is disposed loosely (not contained) atop the low pressure aperture (508, 608, 708) and is not contained. (FIG. 4 is also relevant, but does not show the abrasive material.) These examples are intended to illustrate some operating principles of the basic device. Some practical examples (embodiments) will now be described which (importantly) disclose pouches or bags for containing the abrasive material, external to the device (as contrasted with the device shown in FIGS. 1A,B,C where the powder is contained in the device).

### Some Embodiments of the Dental Micro-Abrasive Delivery Device

FIG. 8A illustrates a very simple, basic, “real world” embodiment (example) of the invention, and is similar to some of the embodiments described hereinabove. More particularly:

This embodiment comprises a device 800 (previously referred to as a “tube”), similar to the device 400 discussed with respect to FIG. 4 or the device 600 discussed with respect to FIG. 6. The device comprises:
an inlet portion 802 (compare 602),
an outlet portion 804 (compare 604),
a reducer portion 806 (compare 606),
an aperture (inlet orifice; low pressure inlet) 808 (compare 608); and
an expansion chamber 812 (compare 612).
This embodiment also comprises a nozzle 814, similar to what was discussed with respect to the nozzle 614 shown in FIG. 6. More particularly, the nozzle 814 extends from within the outlet portion 804 of the device 800. The nozzle may be long, and bendable, and may extend into the outlet portion of the tube nearly to the reducer portion, without blocking the low pressure aperture. The diameter of the outlet portion of the tube may be enlarged to accommodate the nozzle being inserted therein so that the resulting inner diameter of the outlet portion, including the nozzle, is substantially equal to the inner diameter of the outlet portion without the nozzle.
In this embodiment, the nozzle 814 may or may not be movable. Compare the nozzle 1114 shown in FIGS. 11A, 11B and 11C.

This simple, straightforward embodiment may be used in conjunction with a powder containing bag or pouch, as illustrated in FIG. 8B.

FIG. 8B illustrates an embodiment of the invention, wherein the device 800, pierces through a powder pouch 830, mounted to a dental handpiece adapter 850. The powder pouch 830 may or may not be considered to be an element of the device 800, but it is necessary to be used with the device 800, and several powder pouches may be sold with the device 800 or supplied as “consumables” for use with the device 800. The dental handpiece adapter 850 is not an element of the device 800.

In this example, the device 800 shown in FIG. 8A, having a needle-like nozzle 814 extending from the outlet portion 804 of the device 800, may be used to pierce through a bag or pouch 830 containing micro-abrasive powder (not shown, compare 610), and positioned with the low pressure aperture 808 of the device 800 being located within the pouch 830 so that the micro-abrasive powder can be sucked into the device 800 when air pressure is provided by the dental handpiece adapter 850.

The pouch 830 may be formed of polyethylene film having a thickness of 0.125 mm (0.005 inch), and may resemble a small pouch used to contain individual portions (servings) of instant coffee, or sugar. The pouch 830 may contain approximately 15 grams or approximately 12 ml of micro-abrasive powder.

The pouch 830 does not need to be vented to the atmosphere since it is very flexible and will collapse upon itself as micro-abrasive powder is extracted therefrom by pressurized air passing through the device 800. Collapsing (movement) of the pouch 830 created by the venting of the powder acts may beneficially agitate the micro-abrasive powder to facilitate smooth and continuous (uninterrupted, while pressurized air is flowing through the device) introduction of powder into the airstream and exiting the nozzle 814 of the device 800.

FIG. 8C illustrates an embodiment of the invention, wherein a standard polyethylene bag 832 containing micro-abrasive powder is illustrated being pierced by the a micro-abrasive delivery device 800. This embodiment (example) is similar to the example described with respect to FIG. 8B in that the device, with nozzle extending therefrom, is used to pierce a pouch containing micro-abrasive powder, with the low pressure aperture of the device being located within the pouch so that the powder can be sucked into the device 800 when air pressure is provided by a dental handpiece adapter.

In this example, the pouch 832 is larger than the pouch 830 shown in FIG. 8B, and may be a conventional zip-lock bag. For example, the pouch (bag) 832 may contain approximately 2 grams or approximately 1.5 ml of micro-abrasive powder.

The pouch (bag) 832 does not need to be vented to the atmosphere since it is very flexible and will collapse upon itself as micro-abrasive powder is extracted therefrom by pressurized air passing through the device.

FIG. 8D illustrates an embodiment of the invention, using a standard polyethylene pouch (bag) 834 containing micro-abrasive powder. The device 800—more particularly, the nozzle 814 thereof—is shown pierced through the pouch 834. A stream of air and powder, represented by dots, is shown exiting the nozzle. Compare FIGS. 1B and 1C.

In this example, the pouch (bag) 834 is larger than the pouch (bag) 832 shown in FIG. 8C, and may be a conventional zip-lock bag. For example, the pouch (bag) may contain approximately 20 grams or approximately 16 ml of powder.

FIG. 9A illustrates an embodiment of the invention showing a micro-abrasive delivery device having 900 a platform for receiving a bag containing micro-abrasive powder. This embodiment (example) is similar to what was shown in FIG. 7. More particularly the device has an inlet portion 902 (compare 702), an outlet portion 904 (compare 704), a nozzle 914 (compare 714), and a powder container base (platform) 920 (compare 720).

In the FIG. 7 embodiment, a supply of powder is shown disposed on the platform, and the low pressure vent extends through the platform so that the powder can be introduced into the airflow through the device.

In this embodiment, the platform 920 may be utilized to create a gusset plate or base to receive an opening of the bag 930 so that it may be more stable than the arrangements shown in FIGS. 8B, 8C and 8D (for example).

Additionally, the low pressure vent 908 (compare 708) may be in the form of a slot (elongated opening), rather than a simple hole, and a closure (aperture exposure control element) may be provided to selectively close off part or all of the vent 908 to control the concentration of powder captured by the negative pressure resulting from airflow through the device (Bernoulli's Principle). FIGS. 10A,B,C will illustrate how the slot may be open, partially open or closed, using an aperture exposure control to regulate the amount of powder being mixed into the air streaming through the device.

FIG. 9B illustrates the device 900 of FIG. 9A, with a bag 930 (compare 830, 832, 834) containing micro-abrasive powder mounted (sealed) to the platform 920 of the micro-abrasive delivery device. The device 900 is shown connected to a dental handpiece adapter 950 (compare 850).

In this example, an open (bottom, as viewed) end of the bag is mounted to the perimeter (periphery) of the platform 920, such as by heat sealing.

The platform 920 may be round, circular, oval, rectangular, or diamond shaped (as shown), may be formed of a plastic material, such as approximately polyethylene, and may have a perimeter dimension (or circumference, if circular) of approximately 113 mm.

The perimeter dimension of the platform 920 should be approximately equal to or slightly less than the size of the opening of the bag 930. The platform attachment to the bag is a well establish technology known as “spout pouch” which is utilized for low-cost liquid and powder bags mainly in the food industry.

The following three figures (FIGS. 10A,B,C) illustrate a device 1000 (compare 900) previewed in FIG. 9A with a slot 1008 (compare 908) in the platform 1020 (compare 920) functioning as the low-pressure aperture. The device has an inlet portion 1002 (compare 902), an outlet portion 1004 (compare 904), a nozzle 1014 (compare 914), and a platform 1020 (compare 920) with a slot 1008 (compare 908; the slot may not be visible in some of the three figures). A bag containing powder (compare 930) is omitted from these figures, for illustrative clarity.

The device 1000 shown here includes an aperture exposure control 1060 regulates the amount of powder being mixed into the air streaming (passing) through the device by opening, partially opening or closing the slot.

As will be seen, the aperture exposure control 1060 may comprise a cover element 1062 disposed on the top surface of the platform 1020, and a lever element 1064 disposed on a bottom surface of the device 1000.

The cover element 1062 is movable, such as pivotable, to cover (FIG. 10A), partially cover (FIG. 10B), or uncover (FIG. 10C) the slot (aperture) 1008 in the platform 1020. The cover element 1062 may be disposed at a top (upper) end of an axle (not visible) which extends through the platform 1020.

The lever element 1064 is movable, such as pivotable, to cause the cover element 1062, to cover (FIG. 10A), partially cover (FIG. 10B), or uncover (FIG. 10C) the slot (aperture) 1008 in the platform 1020. The lever element 1064 may be disposed at a bottom (lower) end of the aforementioned axle (not visible) which extends through the platform 1020 without interfering with the flow of air through the device 1000.

By moving the lever element 1064, a user is able to regulate the amount of powder being sucked into the airstream passing through the device 1000.

FIG. 10A illustrates embodiment of the invention showing a micro-abrasive delivery device having a platform for receiving a bag containing micro-abrasive powder, with the aperture exposure control incorporated into the device, with the lever of the aperture exposure control in a sealed (closed) position (powder aperture closed, cover element sealing the aperture). Since the cover element 1062 is covering the aperture (1008), the aperture is not visible in this view.

FIG. 10B illustrates an embodiment of the invention showing a micro-abrasive delivery device having a platform for receiving a bag containing micro-abrasive powder, with the aperture exposure control incorporated into the device, with the lever of the aperture exposure control in a half-open position (powder aperture partially closed, cover element partially sealing the aperture). Since the cover element 1062 is partially covering the aperture 1008, the aperture is only partially visible in this view.

FIG. 10C shows a micro-abrasive delivery device having a platform for receiving a bag containing micro-abrasive powder, with the aperture exposure control incorporated into the device, with the lever of the aperture exposure control in a full-open position (powder aperture fully open, cover element fully exposing the aperture). Since the cover element 1062 is not covering the aperture 1008, the aperture is visible in this view.

In use, the user manipulates the lever element to permit (control, select) a desired amount of powder to be mixed into the air stream flowing through the device.

FIGS. 10A,B,C are illustrative of only one embodiment for creating a movable cover element for selectively covering the aperture-acting as a valve. There are many other options for creating the valve, such as a rotating or linear element that would control the aperture dimensions.

FIGS. 11A,B,C are diagrams illustrating an embodiment of the invention wherein aperture exposure is implemented by moving the nozzle in and out (axially) to selectively expose none, some or all of the aperture.

These figures are based on a device such as shown in FIG. 6. with a nozzle extending from within the outlet portion of the tube. In the FIG. 6 embodiment, the nozzle was fixed (firmly embedded) in the outlet portion of the tube. In this embodiment, the nozzle may be moved in and out of the outlet portion of the tube, with a moderate amount of resistance. A stop (not shown) may be incorporated to prevent the nozzle from being completely withdrawn from the outlet portion of the device. The movable nozzle feature described herein could also be applied to a FIG. 7 type device.

FIGS. 11A,B,C show a DENTAL MICRO-ABRASIVE DELIVERY DEVICE 1100 (compare 600) having:
an inlet portion 1102 (compare 602)
a reducer portion 1106 (compare 606)
an outlet portion 1104 (compare 604)
an aperture (or slot) 1108 (compare 608)
a nozzle 1114 (compare 614)

Omitted from these figures, for illustrative clarity, are:
a source of pressurized air (typically from the dentist's chair)
a quantity of powder (compare 610) available to the aperture (or slot) 1108

FIG. 11A shows the nozzle 1114 pushed all the way in. In this position, the nozzle completely blocks (closes) the aperture (slot), cutting off powder flow in response to air flowing through the device, and sealing the powder to keep it fresh until use.

FIG. 11B shows the nozzle 1114 pulled partially out. In this position, the nozzle partially blocks (closes) the aperture (slot), allowing for some powder flow in response to air flowing through the device.

FIG. 11C shows the nozzle 1114 pulled further (fully) out. In this position, the nozzle fully exposes the slot, allowing for maximum powder flow in response to air flowing through the device. In this figure, the expansion chamber 1112 (compare 612) is labeled.

The aperture (slot) 1108 may be rectangular—for example, longer in the axial dimension than in the circumferential direction.

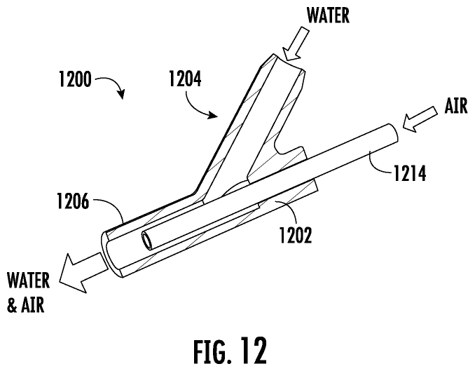

Provisional application U.S. 63/776,965 filed 25 Mar. 2025 disclosed (FIGS. 12A,B therein) a dental micro-abrasive delivery device mounted on a dental connector, a dental micro-abrasive delivery device being held by a user for performing a prophylaxis procedure.

### Water Suppression System for Dental Air-Particle Surface Treatment Systems

Parent application U.S. Ser. No. 18/600,722 discloses a water source having a flexible tube for discharging water is provided for use in conjunction with a micro-abrasive blasting device so that water may be dispensed onto or around or in close proximity with the distal end or tip of the discharge conduit of said device to generate a water mist for suppressing powder aeration when dental procedures such as abrasion or polishing procedures are being performed. The water source may be separate from or self-contained with the micro-abrasive blasting device. An overlay water nozzle may be used to position distal ends of the flexible tube and discharge conduit in close proximity with one another. (ABSTRACT)

Of particular interest in the parent application are FIGS. 2-5 wherein:
FIG. 2 of the parent application is a diagram of a micro-abrasive blasting system comprising a micro-abrasive mixing device and a water supply mounted thereto, for performing a dental procedure on a patient, according to an embodiment of the invention.

FIG. 2 of the parent application is reproduced as FIG. 2 herein.
FIG. 3 of the parent application is a diagram of a micro-abrasive blasting system comprising a micro-abrasive mixing device and a water supply which is not mounted to the device, for performing a dental procedure on a patient, according to an embodiment of the invention.
FIG. 4 of the parent application is a simplified diagram of a micro-abrasive blasting system comprising a micro-abrasive mixing device and an external water supply, for performing a dental procedure on a patient, according to an embodiment of the invention. It may be noted that FIG. 3 of provisional 63/451,225 is a photograph showing a detailed view of the tip (discharge nozzle) of the micro-abrasive mixing device inserted into a distal end of the flexible tube carrying water, such as is illustrated in FIG. 4 herein.
FIGS. 5A,B of the parent application are illustrations of an “overlay water nozzle”, wherein distal ends of a flexible tube supplying water and a discharge conduit (nozzle) supplying abrasive material and air are joined (combined) with one another at their distal end portions by a tube attachment for delivering water and air (with abrasive) to a target, according to an embodiment of the invention. FIG. 5A is a “see through” view, and FIG. 5B is a cross-sectional view.

The overlay water nozzle shown in FIGS. 5A,B of the parent application are reproduced as FIGS. 12A,B herein.

FIG. 12 shows an “overlay water nozzle” or “tube attachment” component 1200, the purpose of which is to facilitate reliable placement and secure mounting of the water delivery tube (hose) coming from the water supply (whether external or self-contained) and the discharge conduit (nozzle) of the device supplying abrasive material and air to ensure appropriate positioning of water to suppress the aeration of expressed powders during delivery.

The overlay water nozzle 1200 may be used in order to keep distal ends of the air/abrasive delivery tube (nozzle) 1214 (compare 1314) and the water delivery tube (not shown, see 1327) positioned close to and in a predetermined relationship with one another. The overlay water nozzle maintains a distal end of the tube for providing water from the water source in close proximity to a distal end of the discharge conduit providing the abrasive material from the mixing chamber.

The overlay water nozzle 1200 provides for mixing of fluid (water) and powder (abrasive) prior to discharge.

The overlay water nozzle 1200 is shown as being mounted onto the air/abrasive nozzle 1214. The overlay water nozzle may be made of plastic, hollow, and may support a barb type connection for mounting the water delivery tube (hose).

The overlay water nozzle may be generally Y-shaped, having two inlets 1202, 1204 and one outlet 1206. Air (which may be mixed with abrasive) is shown (“air”) flowing through the air/abrasive delivery tube 1214 and into the inlet 1202 of the overlay water nozzle 1200.

The discharge conduit (labeled “air abrasive nozzle”) of a micro-abrasive blasting device (not shown) is shown inserted through the inlet 1202 of the overlay water nozzle, passing through the overlay water nozzle directly (in a straight line) towards the outlet 1206.

The discharge conduit may extend (as shown) nearly to the outlet end of the overlay water nozzle. Alternatively, the discharge conduit may extend (as shown) to the outlet end of the overlay water nozzle. Or, the discharge conduit may extend (as shown) beyond the outlet end of the overlay water nozzle 1200.

The water delivery tube (not shown) from the water supply may be inserted into (or onto) the inlet 1204 of the overlay water nozzle 1200.

The inside diameter (ID) of the overlay water nozzle may be slightly larger than the outside diameter (OD) of the discharge conduit of a micro-abrasive blasting device to allow water from the water delivery tube pass through the outlet portion of the overlay water nozzle and to exit the outlet 1206 of the overlay water nozzle via a small gap (clearance) between the discharge conduit and interior of the overlay water nozzle. This is indicated as “water & air” exiting the overlay water nozzle.

### Integrated Powder and Water Suppression System

According to an embodiment of the invention, the WATER SUPPRESSION SYSTEM FOR DENTAL AIR-PARTICLE SURFACE TREATMENT SYSTEMS disclosed in parent application U.S. Ser. No. 18/600,722 (published as US 2024/0299129) may be combined (integrated) with the DENTAL MICRO-ABRASIVE DELIVERY DEVICE disclosed herein.

A resulting “hybrid” (or integrated) powder and water suppression device has a powder (abrasive) delivery portion and a water (mist) delivery portion, and is intended to be capable of delivering micro-abrasive from a powder chamber and delivering a mist of water from a water/fluid chamber.

An object of the invention is to enable a user (dentist) to perform a micro-abrasive procedure on target (a patient's tooth) while generating a water mist for suppressing powder aeration when dental procedures such as abrasion or polishing procedures are being performed.

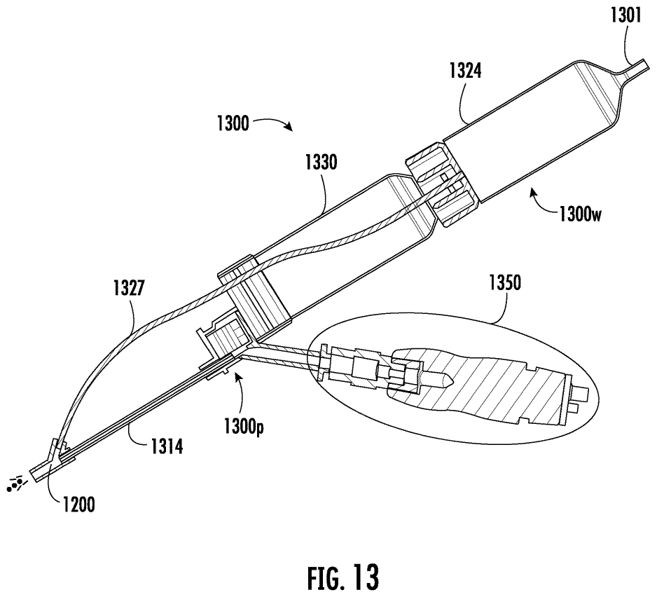

The powder and water suppression device of this invention (shown and described with respect to FIG. 13) is self-contained in that it does not require any electricity to operate, it does not require an external water supply (although having an external water supply is optional), and it does not require an external powder supply. It only requires a dental handpiece adapter to supply pressurized air to the device. Portions of the device, described below, may be filled with micro-abrasive (powder) and water.

The device may be made of polyethylene (plastic) and may be manufactured by injection or blow molding.

Firstly, the design of the DENTAL MICRO-ABRASIVE DELIVERY DEVICE may be enhanced (modified) with a finger actuation movable nozzle that:
seals the powder in the chamber when not in use;
protects the powder chamber from moisture when loading the water/fluid chamber;
allows for operation with only water to clean tooth surfaces;
allows the control powder quantity that comes out of the device; and
makes device more consistent at all chairside air pressures.

This integration of the powder and water suppression systems uses the Bernoulli principle (described hereinabove and in the parent application) to generate ‘negative’ pressure to pull both the powder (abrasive) and the fluid (water).

In the embodiments of the powder delivery device described above (such as shown in FIGS. 8A,B,C,D and FIG. 9B), a plastic bag is used to contain the powder. For various reasons, it was decided to replace the bag with blow-molded pipettes which are made of the same material but support slightly thicker walls (0.020″) which give the pipettes both a little structural rigidity but are sufficiently soft to collapse under the negative pressure.

FIG. 13 is a view of a hybrid (integrated) powder & water delivery device (or system) 1300 combining a variation of the powder delivery device described, for example in FIG. 9B hereinabove, with a variation of the water suppression system disclosed in parent application U.S. Ser. No. 18/600,722 (published as US 2024/0299129)

The device 1300 has a front (or fore) end (left, as viewed) and a rear (aft) end (right, as viewed).

The device 1300 comprises a powder (or micro-abrasive) delivery portion (or component) 1300p and a water suppression (mist delivery) portion (or component) 1300w.

The water delivery portion 1300w includes a “fluid chamber” (see APPENDIX 2).

The powder delivery portion 1300p includes a “powder chamber” (see APPENDIX 2).

The embodiment disclosed in APPENDIX 2 will be discussed below.

The device 1300 is shown connected to a dental handpiece adapter 1350 (compare 850, 950) for providing pressurized air to the device to cause powder and water to be dispensed at a target (such as a patient's tooth). The dental handpiece adapter is not an element of the device.

The powder delivery portion 1300p of the device 1300 contains a quantity such as 15 g of powder in a powder reservoir 1330 (compare 930), and delivers the powder via a nozzle (discharge conduit) 1314 (compare 714, 814, 914). The nozzle 1314 exits the front end of the powder reservoir 1330, The nozzle 1314 may or may not be flexible.

It is intended that the powder delivery portion (or powder chamber) be prefilled with powder, and NOT be refillable.

The water delivery portion 1300w of the device 1300 contains a quantity such as 15 ml of water in a water reservoir 1324 (compare 224), and delivers a mist of water via a flexible water supply tube 1327 (compare 227). The flexible water supply tube 1327 is shown passing through the powder reservoir 1300p (without wetting the powder contained therein).

It is intended that the water delivery portion (or fluid chamber) NOT be prefilled with water, and be refillable. Depending on the procedure being performed and the flow of abrasive material, it may be necessary to refill the water delivery portion a few (such as two or three) times. Also, as discussed below, some procedures (or portions thereof) may be performed with water only (no abrasive material). Since the user loads the fluid into the chamber, other type of fluids may be utilized instead of water. Such fluids may be disinfectants or sterilized fluids for subgingival operatory procedures. The fluid may flavored and warmed up prior to loading into the device to enhance patient comfort.

The water reservoir 1324 and the powder reservoir 1330 may both be cylindrical, measuring 20 mm in diameter and 50 mm in length. The water reservoir 1324 is shown disposed behind and in line (coaxial) with the powder reservoir 1330. This can be termed a “tandem” arrangement of the water reservoir 1324 behind the powder reservoir 1330. The water supply tube 1327 exits the front end of the water reservoir 1324, and is shown passing through the powder reservoir 1330

Alternatively, the powder reservoir 1330 and the water reservoir 1324 may both be flat, rectangular, with the water reservoir 1324 disposed atop the powder reservoir 1330. This “piggyback” arrangement of the water reservoir atop the powder reservoir arrangement could occupy approximately the same space (volume) as the aforementioned tandem arrangement of the water reservoir behind the powder reservoir. Each of the water reservoir 1324 and the powder reservoir 1330 may measure 50 mm in length and 315 mm² in cross-sectional area. Other arrangements of the water reservoir 1324 and the powder reservoir 1330 are deemed to be within the scope of the invention.

A nipple 1301 is shown at the rear (aft; right, as viewed) end of the water reservoir 1324. The purpose of the nipple is to allow water (or other fluid) to be introduced into the water reservoir—in other words, for filling or partially filling the water reservoir. The nipple 1301 also serves as a vent to the atmosphere so that when water is being pulled out of the water reservoir without creating a vacuum in the water reservoir.

The water/fluid system uses a very small ID tubing (0.020″) for the water supply tube 1327 to restrict the flow. The restriction is intended to prevent uncontrolled fluid dripping towards the nozzle or back into the fluid chamber, thereby reducing (or eliminating delay) in water actuation. The water passes via the tube through the center of the powder chamber.

An overlay water nozzle (or tip component) 1200 joins distal (front, fore) ends of the abrasive nozzle 1314 for delivering air (with abrasive) and the water delivery tube 1327 for delivering water to a target (e.g., a patient's tooth). This is illustrated by dots (representing abrasive material) and dashes (representing water mist) exiting the distal (front, fore) end of the overlay water nozzle 1200.

When pressurized air is supplied to the device, powder may be discharged from the nozzle and water may be discharged from the tube. In both cases, these discharges are NOT directly a result of the pressurized air pushing the powder and water from the device, but rather the powder and water are drawn from the device due to the construction of the device creating low pressure areas, and it is (higher) ambient air pressure that causes the powder and water to be discharged (expelled) from the device.

### APPENDIX 2

APPENDIX 2 shows an embodiment of a hybrid (integrated) powder & water delivery device (or system) similar to that shown in FIG. 13. A difference is in the construction and operation of the actuator for controlling powder delivery, and enabling other functions.

FIG. 14 shows the device 1400 (compare 1300), various portions of which are described in detail in APPENDIX 2. At a “macro” level, the device 1400 compares with the device 1300, as follows:
The device 1400 has a fluid chamber 1424 (compare water reservoir 1324) disposed “in tandem” behind a powder chamber 1430 (compare powder reservoir 1330).
The device 1400 has an actuator 1460 which performs the function of the actuator 1060 (regulating discharge of abrasive), and more (as described below).
The device 1400 connects to a dental handpiece adapter 1450 (compare 1350) for providing pressurized air to the device to cause powder and water to be dispensed at a target (such as a patient's tooth). The dental handpiece adapter is not an element of the device.
The device 1400 has a nipple 1401 (compare 1301) for enabling filling of the fluid chamber 1424, and allowing venting to the atmosphere.
The construction of the actuator 1460, which is disclosed in detail in APPENDIX 2, allows for the device 1400 to have greater functionality and enhanced ergonomics when contrasted with the device 1300.

Page 1 of APPENDIX 2 shows a Fully assembled device with powder and fluid chambers and Finger Actuation for Powder Flow Control. As noted therein:
Fluid (from the fluid chamber) passes thru the powder chamber via tube (compare 1327)
The powder chamber is sealed until the actuator is depressed.

The actuator performs the basic function of the previously described aperture exposure control 1060—i.e., controlling powder being ejected by the device. In this embodiment, the actuator performs additional functions discussed in subsequent pages of the appendix.

Page 2 of APPENDIX 2 shows that the device has a loop in the fluid tube (internal to the fluid chamber, or internal to the powder chamber as it passes therethrough) to reduce fluid from getting sucked into the tube during filling (described at page 3) and to prevent fluid from leaking out of the device when pressurized air is not being supplied to the device such as during pauses when performing a lengthy procedure.

Page 3 of APPENDIX 2 shows filling the fluid chamber (with water, or any desired fluid). With the powder chamber sealed, and the device connected with the dental chair pressurized air source (compare 1350), the aft end of the fluid chamber is submerged in a suitable fluid container. With air flowing through the device, fluid is pulled into the fluid chamber via the nipple 1401 (compare 1301).

The nipple 1401 (also 1301) may have a very small inside diameter (ID), such as 0.75 mm. This is sufficiently large to allow fluid to be drawn into the fluid chamber with the negative pressure resulting from pressurized air supplied by the dental handpiece adapter. This is too small to use a check valve to prevent fluid from escaping from the fluid reservoir via the nipple. The nipple's small size will tend to restrict water from escaping. A loop in the tube on the fluid fill size (discussed at page 2 of the appendix) will tend to inhibit water from leaking out of the fluid reservoir during use or resting in the dental chair hanger. It is generally intended that the fluid reservoir is emptied when not in use. This can be done by spraying fluid only, as discussed at page 4 of the appendix.

Page 4 of APPENDIX 2 shows performing fluid spray without associated (contemporaneous) powder delivery. Since the actuator is not depressed, the powder chamber is sealed, and fluid passes through the powder chamber via the fluid delivery tube. It should be understood that the fluid delivery tube could be routed other than through the powder chamber.

Page 5 of APPENDIX 2 shows more about performing fluid spray without powder delivery.

Page 6 of APPENDIX 2 shows, in greater detail, the actuator shown at page 5 of the appendix.

Page 7 of APPENDIX 2 shows, in greater detail, the actuator shown at page 5 of the appendix.

Page 8 of APPENDIX 2 shows the nozzle unsealing with finger actuation. Powder is introduced into the airstream, Actuation moves the nozzle actuation sleeve forward, which moves the nozzle and flexible tube to expose the powder chamber to suction. When loading fluid into the device no actuation is applied thereby making sure no fluid migrates into the powder chamber

Page 9 of APPENDIX 2 shows the device, in operation, delivering fluid (typically water) and powder (micro-abrasive), via an overlay water nozzle (compare 1200).

The device is intended to be single-use, disposable. The ability to refill the fluid reservoir is intended only to ensure that enough fluid is available to be used in a single procedure (i.e., with a given patient).

The same or an additional actuator can be utilized to pinch-off the water tube to provide a powder only operation even when the fluid chamber is filled with fluid. This gives the user the following operational options (selections):
Water only
Powder only
Water and Powder
Pressurized Air only

The actuator, which may be finger-movable, may enable/perform the following:
1. Seals the powder in chamber prior to and when not in use
2. Protect the powder chamber from moisture when loading the water/fluid chamber
3. Allows for operation with only water to clean tooth surfaces (air only with no nozzle movement/actuation)
4. Allows the control powder quantity that comes out of the device by controlling the nozzle aperture opening via the finger actuator position control.
5. Makes device more consistent at all chairside air pressures since powder quantity can be controlled.

The spring (see page 1 of APPENDIX 2, and FIG. 14) in the actuator (1460) may be replaced with rubber type (elastically deformable) material since actuation travel distance is very small.

Similarities and Contrasts with U.S. Ser. No. 18/600,722 Filed 10 Mar. 2024 (Parent Application)

The present invention and the invention disclosed in the parent application disclose different embodiments of devices for generating a water mist for suppressing powder aeration when dental procedures such as abrasion or polishing procedures are being performed. Some similarities and differences (in some of the embodiments disclosed in the parent and present applications) may include:
the devices of the parent and the present applications both have a cartridge (or reservoir) containing abrasive material (powder);
the devices of the parent and the present applications both have a cartridge (or reservoir) containing fluid (water);
the device of the parent application disclosed the water supply (cartridge) mounted “piggyback” on the powder supply (cartridge);
the device of the present invention discloses mounting the water supply (cartridge, chamber) behind (in tandem with) the powder supply (cartridge, chamber);
the devices of the parent and the present applications both connect to a dental handpiece adapter for providing pressurized air to the device;
the devices of the parent and the present applications both do not require connection to a chairside supply of water;
the device of the parent application utilizes pressurized air to (directly) force the discharge of powder from the device;
the device of the present invention utilizes the Bernoulli principle to (indirectly) suck powder from the device;
the devices of the parent and the present applications both utilize the Bernoulli principle to suck water (fluid) from the device;
the device of the parent application optionally utilizes pressurized air to (directly) force the discharge of water from the device;
utilizing the (Bernoulli) principle of negative pressure for causing the discharge of water may be superior to directly forcing the discharge of water, it may reduce the number of s components and user setup steps;
the devices of the parent and the present applications both utilize an overlay water nozzle to combine the discharges of abrasive and water;
the device of the parent application contains a supply of water, and is not refillable;
the device of the present invention allows for repeated filling of the water reservoir;
the device of the parent application does not provide means for regulating the amount of abrasive being delivered;
the device of the present invention has an actuator for controlling (regulating) the discharge of abrasive from the device;
the device of the parent application does not provide means for delivering fluid without delivering abrasive;
the actuator of the device of the present invention allows for fluid spray without powder.

Regarding some of the prior art cited during prosecution of the parent application:
Gallant (U.S. Pat. No. 4,522,597) discusses using his system for dental prophylaxis, including the cleaning of teeth, the removal of stain and of plaque or calculus, and employs the discharge of a gaseous jet from a nozzle or discharge orifice generates a low pressure area immediately surrounding the discharging gas. This low pressure area is present in the operation of the equipment described and creates what may be termed an ambient induction zone immediately surrounding the jet downstream of the jet discharge orifice.
Gallant requires connecting his system to chairside (pressurized) water;
Applicant's devices have a cartridge (reservoir) for containing water, which is well suited to delivering heated water, or other fluids with flavor or medicament;
Applicant's devices uses the Bernoulli principle to pull the water from the reservoir to the nozzle. The water starts and stops in response to the air flow and does not require its own control mechanism. Water (fluid) is not delivered under pressure.
Gallant discloses a complicated system comprising control equipment;
Applicant's devices are very simple, inexpensive to manufacture (mostly, if not entirely made of plastic), and are intended to be handheld (in their entirety), and disposable;
The device of Applicant's parent application may be retrofitted to an existing Groman device which delivers only powder.

While the invention(s) has/have been described with respect to a limited number of embodiments, these should not be construed as limitations on the scope of the invention(s), but rather as examples of some of the embodiments. Those skilled in the art may envision other possible variations, modifications, and implementations that are also within the scope of the invention(s), based on the disclosure(s) set forth herein.

What is claimed is:

1. Dental micro-abrasive delivery device comprising a tubular structure having:
an inlet portion adapted to connect with a pressurized air supply from the dentist's chair;
a reducer portion in downstream fluid communication with the inlet portion;
an outlet portion in downstream fluid communication with the reducer portion and having a diameter greater than the reducer portion; and
an inlet orifice (low pressure inlet, aperture; slot) at the inlet end of the outlet portion, slightly downstream of the reducer portion.

2. The dental micro-abrasive delivery device of claim 1, further comprising:
a nozzle extending from the outlet portion.

3. The dental micro-abrasive delivery device of claim 2, wherein:
the nozzle is flexible.

4. The dental micro-abrasive delivery device of claim 2, wherein:
the nozzle is movable to selectively block, partially block, or open the inlet orifice.

5. The dental micro-abrasive delivery device of claim 1, further comprising:
a pouch or bag for supplying micro-abrasive in powder form to the inlet orifice.

6. The dental micro-abrasive delivery device of claim 1, further comprising:
a platform disposed atop the tubular structure; and
a bag containing micro-abrasive powder mounted to the platform.

7. The dental micro-abrasive delivery device of claim 6, wherein:
the aperture (slot) extends through the platform; and
further comprising:
a movable cover element for selectively covering the aperture.

8. Dental powder delivery and water suppression device comprising:
a powder (micro-abrasive) delivery portion having a powder cartridge (chamber, reservoir) prefilled with powder and a nozzle extending from the powder cartridge;
a water (fluid) delivery portion having a fluid cartridge (chamber, reservoir) which is fillable with water and a tube extending from the fluid cartridge;
wherein the device can be connected with a dental handpiece adapter providing pressurized air to the device.

9. The device of claim 8, wherein:
the nozzle is made of stainless steel, aluminum, or plastic and is flexible or bendable.

10. The device of claim 8, wherein:
when pressurized air is supplied to the device, powder is discharged from the nozzle and water is discharged from the tube in response to lower than ambient air pressure in low pressure areas of the device rather than the pressurized air pushing the powder and air from the device, in accordance with Bernoulli's principle.

11. The device of claim 8, further comprising:
an overlay water nozzle having a first inlet for the nozzle, a second inlet for the tube, and an outlet.

12. The device of claim 8, further comprising:
an actuator for sealing the powder within the powder cartridge, and for controlling the amount of powder being discharged from the device.

13. The device of claim 12, wherein:
the actuator selectively allows for delivery of (i) water only, (ii) powder only, (iii) water and powder, and (iv) pressurized air only.

14. The device of claim 8, wherein:
the water cartridge is disposed in tandem with, behind the powder cartridge.

15. The device of claim 8, wherein:
the device does not require any electricity to operate.

16. The device of claim 8, wherein:
the device does not require a connection with an external water supply to operate.

17. The device of claim 8, wherein:
the device requires only a connection with a dental handpiece adapter supplying pressurized air to operate.

18. The device of claim 8, wherein:
the device is made primarily of plastic and is manufactured by 3D printing or injection molding or blow molding.

19. A method of performing a dental procedure, comprising:
providing a dental micro-abrasive delivery device containing a first cartridge (reservoir, chamber) prefilled with powder (micro-abrasive) and a second cartridge (reservoir, chamber) which his fillable with fluid (water);
supplying pressurized air to the device;
causing powder and water to be discharged from the device in response to lower than ambient air pressure in low pressure areas of the device rather than the pressurized air pushing the powder and air from the device.

20. The method of claim 19, further comprising:
selectively providing for at least one of delivery of (i) water only, (ii) powder only, (iii) water and powder, and (iv) pressurized air only;
wherein when powder is being delivered, controlling the amount of powder being discharged from the device.
